(19) United States
(12) Patent Application Publication
(10) Pub. No.: US 2003/0066393 A1
(43) Pub. Date: Apr. 10, 2003

(54) Double-ended fastening device for applying a predetermined clamp-up load

(75) Inventor: Kenneth E. Mageson, Granbury, TX (US)

Correspondence Address: HUGHES LUCE LLP, Suite 2800, 1717 Main Street, Dallas, TX, 75201, US

(73) Assignee: Lockheed Martin Corporation, Bethesda, MD (US)

(21) Appl. No.: 09/974,412

(22) Filed: Oct. 10, 2001

(51) Int. Cl. B25B 13/00

(52) U.S. Cl. 81/125.1

(57) ABSTRACT

The present invention provides a double-ended wrench comprising a main body or cross-piece section having a first end and second end. Fastener-gripping ends are coupled to opposite ends of the main body at the first and second ends. Furthermore, the fastener-gripping ends contain sockets or drivers that are indexed or offset at an angle to each other allowing an operator to orient the wrench in order to more easily grip the fastener in an obstructed area. Therefore, by sequential application of the sockets to the fastener, the fastener maybe repeatedly rotated in the same direction while the wrench undergoes a swing with a limited arc. The size of the arc is dependent upon the geometry of the socket and the offset angle.

### RELATED APPLICATIONS

This application is related to U.S. application Ser. No. 09/499,620, filed Feb. 7, 2000 entitled “System and Method for Applying a Predetermined Clamp-Up Load with a Double-Ended Fastening Device.”

### TECHNICAL FIELD OF THE INVENTION

The present invention relates generally to socket-type fastening systems and methods, and more particularly, to a system and method for a double-ended socket-type device that applies a predetermined clamp-up load on the fastener.

### BACKGROUND OF THE INVENTION

The utility and convenience of a single-sided or two-sided wrench is well-established. These wrenches can be purchased in various lengths and socket sizes and are most often designed with a straight body. However, specialized wrenches are often required to accommodate a specific application in areas with obstructed access.

Most wrenches, because of their straight-body design, are limited to use on fasteners that are easily accessed. When a fastener is located within or near an obstruction, it is very difficult, at best, to properly place the wrench over the fastener. Additionally, because of the obstruction, it is more difficult to grip the wrench so that a torque can be applied to the fastener at a practical angular displacement without injuring the operator.

It would be desirable to have a wrench that allows an operator to apply a practical and convenient torque to a fastener located near or within an obstructed area. Furthermore, it would be desirable to index the sockets or drivers of a double-ended wrench in order that the socket can easily grasp the fastener in a convenient and unobstructed manner.

### SUMMARY OF THE INVENTION

The present invention provides a socket-type fastening system that substantially eliminates or reduces disadvantages and problems associated with prior systems. More particularly, one embodiment of the present invention provides a system and method for a double-ended socket-type device that can be used to apply a predetermined clamp-up load on a fastener.

The most general embodiment of the present invention provides a double-ended wrench comprising a main body or cross-piece section having a first end and a second end. Fastener-gripping ends are coupled to opposite ends of the main body at the first and second ends. Furthermore, the fastener-gripping ends contain sockets or drivers that can be indexed or offset at an angle to each other, allowing an operator to orient the wrench in order to more easily grip the fastener in an obstructed area. Therefore, by sequential application of the sockets to the fastener, the fastener may be repeatedly rotated in the same direction while the wrench undergoes a swing with a limited arc. The size of the arc is dependent upon the geometry of the socket and the offset angle.

In an alternate embodiment, the driver is adapted to thread a fastener onto a pin and to deform external lobes of the fastener plastically into the fastener and to deform fastener material ahead of the deforming lobes into void spaces between the fastener and the pin. This deformation locks the fastener and the pin together and removes the purchase that the driver had on the fastener, thereby preventing further tightening of the fastener.

In one form the driver has a socket with flats that in cross section fall on the sides of a regular polygon. The flats bear on lobes of a fastener to thread the fastener onto the pin, and, when the fastener engages a workpiece with sufficient axial force, to plastically deform the lobes into the body of the fastener, terminating wrenching and locking the fastener and pin together. The flats extend substantially parallel to the axis of the setting tool so that they substantially parallel the lobes they engage. Preferably, a pilot section below the wrenching and deforming flats has a surface that sets over a pilot section of the fastener to maintain the driver and the fastener concentric. The polygonal cross section of the wrenching and deforming flats can extend into the pilot section, in which case the flats in the pilot section can be relieved to define right cylindrical surfaces that cooperate with a right cylindrical surface of the collar to maintain alignment.

The present invention has several advantages over known prior art in that, first, the sockets or drivers in the opposing ends are oriented or indexed relative to one another, allowing the operator to achieve a greater rotation of the socket about the fastener in a limited access environment.

Another advantage provided by the present invention is that the fastener-gripping ends of the double-ended wrench can be coupled to the cross-piece section with a hinged or flexible device allowing a further range of motion for the socket in an area of limited access.

Still another technical advantage provided by the present invention is a collar or shoulder within the drivers of the wrench that restricts the vertical movement of the fasteners within the driver, thus aiding the operator.

The present invention provides yet another technical advantage in that two (2) drivers or sockets can be located in opposite halves of one end of the double ended wrench. This allows an operator to have a double-ended wrench with up to four different sizes and/or orientations of drivers on the wrench.

Yet another technical advantage of the present invention is that the cross-piece section of the wrench of the present invention can be telescoping. This allows the wrench length to be adjusted dependent upon obstructions that an operator may encounter. In an alternate embodiment, the cross-piece section may be composed of rigidly coupled interlocking pieces. These interlocking pieces may fasten to one another either to form a straight cross-piece section or a multi-angled cross-piece section. This again allows an individual user to configure the wrench to the specific obstructions that may be encountered.

A key aspect of the present invention is to provide a double-ended wrench wherein the fastener-gripping ends each comprise a driver for setting a fastener at a predetermined torque.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 provides a top down view of an embodiment of the double-ended wrench of the present invention having indexed sockets;

FIG. 2 illustrates a second aspect of the present invention wherein the fastener gripping ends are coupled to the main body of the wrench with a flexible device;

FIG. 3 shows that a collar or other retaining device may be incorporated into the socket of the present invention to restrict vertical movement of the fastener in the socket;

FIGS. 4A and 4B provide a top and side view wherein the socket of the wrench of the present invention is divided into an upper and lower half, with each half having a unique size an/or orientation.

FIG. 5 shows an embodiment of the present invention wherein the main body has a variable length;

FIG. 6 depicts an alternate method for achieving a main body with a variable length;

FIG. 7 provides that the main body may be multi-angled according to the method depicted in FIG. 6;

FIG. 8 is a bottom plan view of a preferred form of a driver that attaches the fastener at a predetermined clamp-up load; and

FIG. 9 is a cross sectional view of the driver of FIG. 8 setting a fastener on a pin and a pair of sheets.

### DETAILED DESCRIPTION OF THE INVENTION

Preferred embodiments of the present invention are illustrated in the FIGUREs, like numerals being used to refer to like and corresponding parts of the various drawings.

The present invention relates generally to fastener-type setting tools for setting threaded collars, and, more particularly, to a double-ended wrench comprising a cross-piece section having a first end and a second end. A fastener-gripping end is coupled to both the first and second ends. The sockets or drivers located within the fastener-gripping ends are indexed or oriented at an angle to each other allowing an operator to orient the wrench in order to more easily grip the fastener in an obstructed area.

FIG. 1 presents one embodiment of the present invention. Fastener-gripping ends 16 and 18 are coupled to cross-piece section 10 at first end 12 and second end 14, respectively. FIG. 1 shows a deltoid socket 19 contained within fastener-gripping ends 16 and 18. The deltoid sockets shown are indexed 60° from one another when sockets 19 are applied to a fastener. The wrenching surfaces of the present invention need not be limited to a deltoid or equilateral triangle type socket as shown in FIG. 1. Any socket as known by those skilled in the art may be used in the fastener-gripping ends.

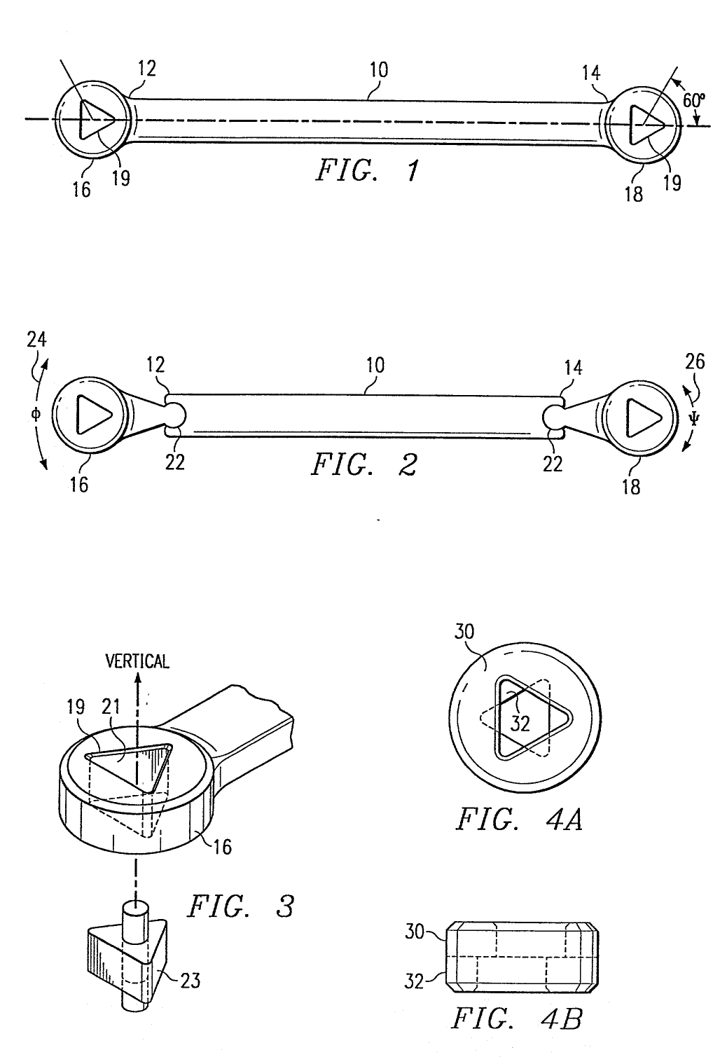

FIG. 2 presents a second aspect of the present invention where the fastener-gripping ends 16 and 18 are coupled to the cross-piece section 10 with a flexible device 22 that allows the fastener-gripping ends 16 and 18 to pivot in a defined arc about at least one axis. These arcs may be defined in a horizontal plane, as illustrated by the arc for angle Φ 24 or in a vertical plane for angle Ψ 26. The flexible device 22 may be a hinge type device, universal-joint type device, ball and socket or other device as known to those skilled in the art. Flexible devices 22 couple the fastener-gripping ends 16 and 18 to the cross-piece section 10 at ends 12 and 14.

The ability to pivot in 2 degrees of freedom allows cross-piece section 10 to be placed in at an angle to the fastener without canting the driver or socket 19 relative to the fastener during the setting up of the fastener. This can ensure maximum contact between the driver's gripping surfaces and the fastener.

Another embodiment of the present invention is illustrated in FIG. 3. FIG. 3 shows a shoulder or collar 21 incorporated into the driver 19 of the fastener-gripping ends 16 and 18. Shoulder or collar 21 restricts the vertical movement of the fastener within driver or socket 19 by providing a barrier or lip that the fastener 23 cannot move past, thereby aiding the operator by preventing the wrench from slipping off the fastener.

FIGS. 4A and 4B illustrate another embodiment of the fastener-gripping end 16 or 18 wherein the driver 19 is divided into an upper half 30 and a lower half 32. The form of the socket cut into upper half 30 may differ from that cut into lower half 32 in either size or orientation. It is important to note that the depth of the upper half 30 and lower half 32 must be of sufficient depth to properly grip the fastener. This allows an operator to merely flip the wrench over in order to gain additional freedom of movement of the wrench in a restricted area.

FIG. 5 depicts a double-ended wrench of the present invention wherein the cross-piece section 10 is a telescoping cross-piece section. A telescoping cross-piece section 10 allows an operator to vary the length of the wrench dependent on the available access that the work area provides the operator. Additionally, the operator may adjust the length of the wrench to achieve a greater torque advantage on the fastener.

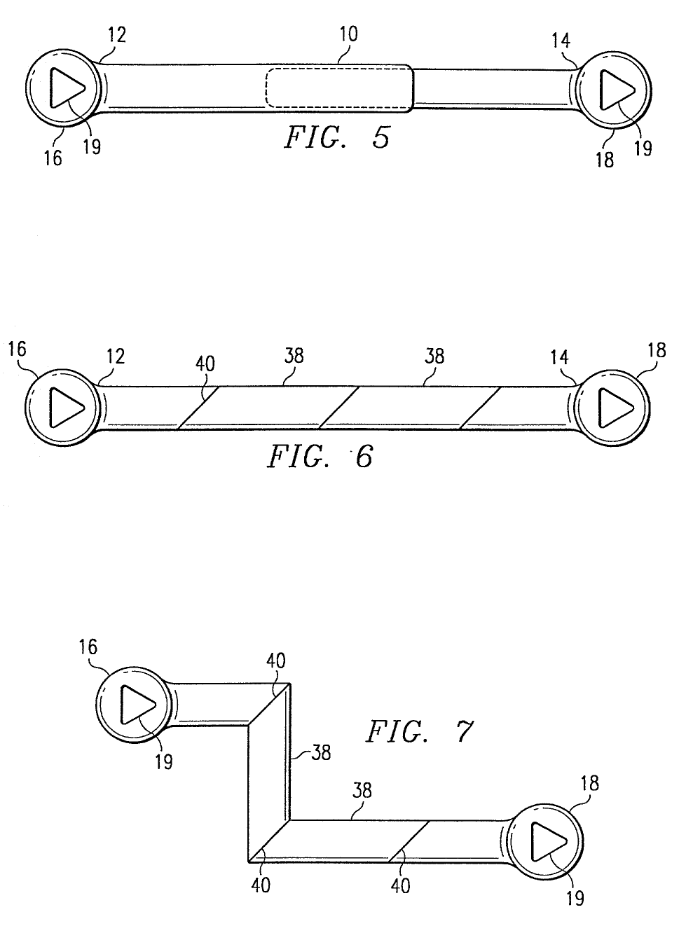

Alternatively, cross-piece section 10 may be comprised of multiple interlocking cross-piece sections 4, as shown in FIG. 6. Interlocking cross-piece sections 4 can be rigidly coupled to one another and allow an operator to create a wrench with an operator-determined handle length.

The interlocking cross-piece sections 4 shown in FIG. 6 interlock to form a straight cross-piece section. However, the present invention need not be limited to a straight cross-piece section. Interlocking cross-piece sections 4 may be curved or may have joints 40 which allow an operator to join interlocking cross-piece sections 4 at an angle, creating a multi-angled cross-piece section 10. Again, this will allow an operator to modify the double-ended wrench to avoid an obstruction in a low-access area.

FIG. 7 shows interlocking cross-piece sections 4 with 11° angled ends. However, the present invention need not be limited to interlocking cross-piece sections 4 having ends at 11°. The interlocking cross-piece sections 4 may be rigidly coupled to each other at any angle between zero and 180°.

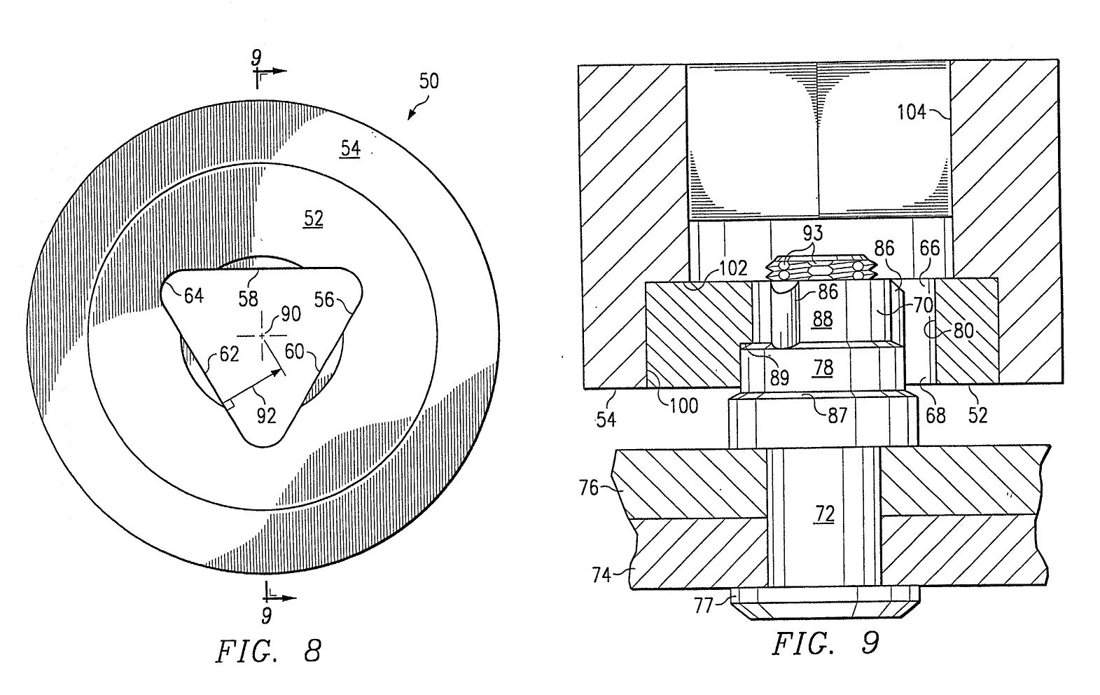

FIGS. 8 and 9 illustrate a preferred driver or socket 50 to be incorporated into the double sided wrench of the present invention. Driver 50 includes an insert 52 and a housing 54. The insert is press-fitted into housing 54. Insert 52 may be made of a hard, wear-resistant material, such as tungsten carbide, while housing 54 may be made of some more ductile and more easily formed material, such as steel.

Insert 52 as shown has a deltoid socket 56. The socket has wrenching and deforming surfaces or flats 58, 60, and 62 that in axial cross section fall on the legs of an equilateral triangle. However, the present invention may use a socket forming any regular polygon. The apexes of this triangle have rounded corners, such as corner 64, between sides 58 and 62.

The deltoid form of the socket may extend completely through insert 52 or merely one half of insert 52. The socket has wrenching and deforming section 66 and a pilot section 68, as shown in FIG. 9. The wrenching and deforming section is responsible for threading a fastener 70 onto a pin 72, tightening the collar on the pin, and clamping a pair of sheets or workpieces 74 and 76 together between the fastener and a head 77 of the pin. The pilot section cooperates with a corresponding pilot section 78 of the pin to keep the driver from canting off the axis of the fastener, that is, keeping the driver and the fastener concentric. Pilot section label 78 has right cylindrical reliefs 80, 82, and 84. These reliefs have a curvature, the radius of which is substantially the same as the radius of pilot section 78 of the fastener. The reliefs extend for substantially the same axial distance as the axial distance of pilot section 78. Fastener 70 has a foot label 85 of major diameter separated from pilot section 78 by an external shoulder 87. Shoulder 87 engages an end 89 of the driver and determines the axial position of the driver with respect to the fastener and locates the wrenching and deforming section in proper axial relationship to the lobes 86. (In FIG. 9, one of the apexes is shown spaced from the shoulder. The flats rapidly reduce in radius from the axis of the fastener and engage the shoulder along the three sides of the triangle.)

Flats 58, 60, and 62 serve to apply a wrenching torque onto fastener 70 by engaging lobes 86 of the fastener. These lobes have at their base a right cylindrical section 88 of the fastener 70, the surface of which is at a constant radius from the axis of the fastener 70. The distance from each of the flats 58, 60, and 62 at its closest approach to an axis of rotation 90 of the driver is the same as the radius of right cylindrical section 90. This line of closest proximity is indicated by the dash line 92 in FIG. 8. Flats 58, 60, and 62, in use, bear on the lobes 86 with ever increasing force after the fastener 70 has been brought to bear on sheets 74 and 76. The stress on the lobes 86 builds up rapidly until the lobes 86 fail plastically in radial compression. Upon the occurrence of such failure, fastener material radially inward of the lobes also fails plastically and displaces into void volumes between the pin and the fastener. Preferably these void volumes are defined by flutes 93 of the pin. The displaced material within these flutes locks the fastener and the pin together against unthreading. With the disappearance of the lobes 86, flats 58, 60, and 62 no longer see fastener material, and the driver can rotate freely on the set fastener.

It is very important that flats 58, 60, and 62 be parallel to axis 90 and of closely controlled distance from that axis. These conditions are necessary to effect a repeatable and accurate displacement of lobe material. If the surfaces were not parallel to the axis, it would be possible for a failure of less than all of the lobe material desired to be failed, with the consequence that the clamp-up load applied by the fastener and the pin on the sheets would be less than design value. The same result obtains if the distance 92 varies appreciably. To obtain these conditions and to have a tool of long life, hardened insert 52 is provided.

It should be noted that the various aspects described above can be present in any combination as an embodiment of the present invention.

In summary, the present invention provides a system and method for applying a torque load with a double-ended fastening device. The device provides a double-ended wrench comprising a main body or cross-piece section having a first end and second end. Fastener-gripping ends are coupled to opposite ends of the main body at the first and second ends. Furthermore, the fastener-gripping ends contain sockets or drivers that are indexed or offset at an angle to each other allowing an operator to orient the wrench in order to more easily grip the fastener in an obstructed area. Therefore, by sequential application of the sockets to the fastener, the fastener may be repeatedly rotated in the same direction while the wrench undergoes a swing with a limited arc. The size of the arc is dependent upon the geometry of the socket and the offset angle.

The present invention has several advantages over known prior art in that, first, the sockets or drivers in the opposing ends are oriented or indexed relative to one another, allowing the operator to achieve a greater rotation of the fastener in a limited access environment.

Another advantage provided by the present invention is that the fastener-gripping ends of the double-ended wrench can pivot over a predetermined arc along either a horizontal or vertical axis. This is achieved by coupling the cross-piece section to the fastener gripping ends with a hinged or flexible device that allows a further range of motion for the socket in an area of limited access.

Yet another technical advantage provided by the double-ended wrench of the present invention is to provide a collar or shoulder within the drivers that restricts the vertical movement of the fasteners within the driver.

Another advantage provided by the present invention is to locate two drivers in opposite halves of one end of the double ended wrench. This allows an operator to have a double-ended wrench with up to four different sizes and/or orientations of sockets on a two-ended wrench.

The present invention provides yet another technical advantage in that the cross-piece section may be of variable length. This can be achieved by telescoping the cross-piece section, allowing the wrench length to be adjusted dependent upon obstructions that an operator may encounter. In an alternate embodiment, the cross-piece section may be composed of rigidly coupled interlocking pieces. These interlocking pieces may fasten to one another either to form a straight cross-piece section or a multi-angled cross-piece section. This again allows an individual operator to customize the wrench to the specific obstructions that may be encountered.

An important technical advantage provided by the present invention is a double-ended wrench wherein the fastener-gripping ends each comprise a driver for setting a fastener at a predetermined torque.

Although the present invention has been described in detail, it should be understood that various changes, substitutions and alterations can be made hereto without departing from the spirit and scope of the invention as described by the appended claims.

What is claimed is:

1. An apparatus for shearing a fastener, the fastener including lobes disposed on the fastener, the apparatus comprising:
a first gripping end and a second gripping end;
the first gripping end comprising a first driver and a second gripping end comprising a second driver offset at an angle relative to the first driver;
the first driver and the second driver configured to apply a torque to the fastener;
the offset between the first driver and second driver configured to provide the torque from the second driver over an additional angular motion relative to the first driver; and
the first and second drivers including a plurality of flats;
the flats engagedly deforming the lobes as a result applying the torque.

2. The apparatus according to claim 1 wherein the fastener includes a threaded bore for receiving a threaded pin.

3. The apparatus according to claim 2 wherein at least one void between the fastener and the threaded pin is filled with material that defines the fastener based on the step of deforming the lobes with the plurality of flats.

4. A method for shearing a fastener with a wrench, the fastener comprising lobes disposed on the fastener and the wrench comprising a first gripping end and a second gripping end, the first gripping end comprising a first driver, and the second gripping end comprising a second driver offset at an angle relative to the first driver, the first and second drivers including a plurality of flats, the method comprising the steps of:
positioning the plurality flats for engagement with the lobes,
the second driver operable to apply a torque to the fastener over an additional angular motion relative to the first driver;
applying a torque to the fastener with the wrench; and
deforming the lobes with the plurality of flats as a result of the step of applying the torque with the wrench.

5. The method according to claim 4 wherein the fastener includes a threaded bore for receiving a threaded pin.

6. The method according to claim 5 further comprising the step of:
filling at least one void between the fastener and the threaded pin with material that defines the fastener based on the step of deforming the lobes with the plurality of flats.

7. The method according to claim 4 further comprising the step of:
releasing a socket from either one of the first or second drivers;
the socket defining the plurality of flats.

8. The method according to claim 4 further comprising the step of:
maintaining the angular motion of the wrench in coaxial relationship with the axis of the fastener in conjunction with the step of applying a torque to a fastener with the wrench.

9. The method according to claim 4 further comprising the step of:
restricting vertical movement of the fastener with either one of the first or second drivers.

10. A method for shearing a fastener with a wrench, the fastener comprising lobes disposed on the fastener and the wrench comprising a first gripping end and a second gripping end, the first gripping end comprising a first driver, and the second gripping end comprising a second driver offset at an angle relative to the first driver, the method comprising the steps of:
positioning the wrench for engagement with the lobes with the first driver;
applying a torque to the fastener with the wrench; and
positioning the wrench for engagement with the lobes with the second driver depending on the direction of the fastener;
applying a torque over an additional angular motion with the second driver relative to the first driver;
selectively deforming, depending on the orientation of the fastener, with either one of the first or second drivers.

11. A method for shearing a fastener with a wrench, the fastener comprising lobes disposed on the fastener and the wrench comprising a first gripping end and a second gripping end, the first gripping end comprising a first driver, and the second gripping end comprising a second driver offset at an angle relative to the first driver, the first and second drivers including a plurality of flats, the method comprising the steps of
applying a preliminary torque with either of the first or second drivers;
the first or second drivers used depending on the orientation of the fastener; and
applying a deforming torque to the fastener with one of the drivers;
the one of the drivers selected based on the orientation of the fastener after the step of applying the preliminary torque.
